(19) United States
(12) Patent Application Publication
(10) Pub. No.: US 2014/0105559 A1
(43) Pub. Date: Apr. 17, 2014

(54) FERRULE FOR A FIBER OPTIC CONNECTOR

(71) Applicant: Gregory Albert Merkel, Corning, NY (US)

(72) Inventor: Gregory Albert Merkel, Corning, NY (US)

(21) Appl. No.: 13/785,519

(22) Filed: Mar. 5, 2013

Related U.S. Application Data
(60) Provisional application No. 61/713,765, filed on Oct. 15, 2012.

(51) Int. Cl. G02B 6/44

(52) U.S. Cl. CPC G02B 6/4436
USPC 385/139

(57) ABSTRACT

A connector assembly for an optical waveguide includes an optical waveguide and a ferrule for receiving the optical waveguide. The ferrule has an exterior and a bore defined by an interior surface of the ferrule. The ferrule includes a main body formed from a first material and a layer of a second material on the interior surface of the ferrule. The first material includes at least one of a glass, a glass-ceramic, a ceramic, and a cermet. The second material includes a silica or silica-rich phase.

### RELATED CASES

This application claims the benefit of priority under 35 U.S.C. §119 of U.S. Provisional Application Ser. No. 61/713,765 filed on Oct. 15, 2012 the content of which is relied upon and incorporated herein by reference in its entirety.

### BACKGROUND

Aspects of the present disclosure relate generally to connectors for optical fibers. More specifically, aspects of the present disclosure relate to a ferrule, such as a ceramic ferrule, for such a connector.

For practical use, optical fibers typically must be capable of being connected to other fibers and to various pieces of network gear and other devices. Such a connection may be a permanent splice at the point of interconnection or, more popularly, a mechanical coupling, which can more easily be decoupled and recoupled multiple times.

Many types of mechanical connectors exist, one of which is an optical fiber “connector plug,” which serves to terminate the end of the optical fiber. Such connector plugs, often referred to simply as “connectors,” typically include a ferrule, which securely encases the terminal portion of the fiber and is itself housed and spring loaded within the distal end of a multi-component plug.

Connection of two fibers may require use of a sleeve-shaped adapter that fastens to each connector plug. Alignment of adjoining fibers and direct contact between their polished ends permits minimal loss in signal transmission, and, ideally, such connectors should still be capable of being disconnected and reconnected hundreds of times. Thus, mechanical durability of the system, including the ferrule, for such a system is beneficial.

In typical high-performance applications, the ferrule to which the terminal end of the fiber is bonded is made of an yttrium-stabilized zirconium oxide (“YSZ”) ceramic. YSZ has long been recognized for its mechanical durability and high fracture toughness, providing it with a high resistance to damage and wear over the course of hundreds of reconnections.

The fiber termination process (e.g., connectorization process) may entail several steps, each of which adds cost to the connector system. For example, the process may include stripping coatings from an optical fiber, inserting the fiber into the ferrule, and using epoxy to secure the fiber to the ferrule. Curing of the epoxy may add significant time to the fiber-to-ferrule attachment process.

Costs of manufacturing plug connectors could be substantially reduced by replacing epoxy with a more rapid “direct bonding” technique, where the bare fiber is bonded directly to a portion of the bore of the ferrule. Additionally, replacement of mechanical polishing of the fiber end by a thermal polishing method may likewise reduce process time and costs of manufacture. However, experiments conducted by the Applicant and/or others from Corning Incorporated to directly bond and thermally polish optical fibers in connector systems that utilize commercially-available YSZ ceramic ferrules have identified several problems to be overcome in order to efficiently employ direct bonding and thermal polishing approaches.

First, it is Applicant's finding through experimentation that direct bonding of the fiber to the ferrule may require the presence of a silica-rich interface on the surface of the bore of the ferrule, which is presently lacking on the YSZ ceramic.

Second, thermal polishing with a 10.6 μm CO₂ laser has been observed to produce cracking on the ferrule face, presumed to be caused by thermal shock stresses associated with the localized heating of the YSZ, which has a high coefficient of thermal expansion, roughly 108×10⁻⁷° C.⁻¹, and low thermal conductivity, such as about 3 W/(m·K).

It is Applicant's finding through experimentation that direct bonding and thermal polishing of the optical fiber without cracking of the ferrule can be achieved for ferrules made of fused silica. Fused silica ferrules provide the desired silica interface to which to bond the fiber, and fused silica has a much lower coefficient of thermal expansion than YSZ, such as about 6×10⁻⁷° C.⁻¹. However, fused silica may lack the mechanical durability required for a ferrule to survive hundreds of disconnect/reconnect cycles in which it may be subjected to impact and sliding contact against the interior of the adapter component of the connector assembly.

Aspects of the present disclosure seek to overcome such problems of currently available ferrules by providing a high-strength, wear-resistant ferrule which possesses a high thermal shock resistance, enabling thermal polishing of the fiber tip, and/or presenting a silica-rich interface in the bore to which the fiber can be directly bonded.

### SUMMARY

One embodiment relates to a ferrule for use in an optical waveguide connector assembly. The ferrule includes a main body of the ferrule formed from a material including a glass, a glass-ceramic, ceramic, cermet, and/or metal silicide having a coefficient of thermal expansion of less than 60×10⁻⁷° C.⁻¹. The interior of the bore of the ferrule includes (e.g., comprises) a fusible inorganic material to which the optical fiber may be thermally bonded. The fusible material may be silica or a silica-rich material, which may be the same composition as that of the body of the ferrule or may be provided as a thin layer of silica or silica-rich material on the surface of the bore. “Silica or silica-rich,” as used herein, means an oxide material having at least 40 mole percent of SiO₂. “Fusible,” as used herein, means a material that will locally flow or melt when heated by a focused energy source such as a laser. When the fusible material is provided as a thin layer, the thickness of the layer is preferably at least 10 μm. In some embodiments, the ferrule may further include an outer thin layer on the exterior of the ferrule, where the outer thin layer includes glass, glass-ceramic, or ceramic having high wear resistance.

Some such ferrules uniquely combine high thermal shock resistance (low CTE), a silica-rich interface for direct fiber attachment, and a surface with high wear and impact resistance. More specifically, according to such an embodiment, the ferrule has the following advantages: (1) a silica or silica-rich layer on the inner surface of the bore of the ferrule may enable a method of directly bonding the fiber to the silica interface in the bore of the ferrule, eliminating costly and time-consuming bonding processes that may entail introduction of epoxy or other such bonding agents; (2) a low CTE may enable a method of thermally polishing the fiber tip by providing a ferrule that will not fracture from thermal stresses generated during laser irradiation of the fiber tip, thereby providing further savings in manufacturing time and cost over existing mechanical polishing methods; and (3) the ferrule maintains adequate wear and impact resistance, as may be beneficial for hundreds of decoupling/re-coupling cycles by virtue of a wear-resistant surface.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying Figures are included to provide a further understanding, and are incorporated in and constitute a part of this specification. The drawings illustrate one or more embodiments, and together with the Detailed Description serve to explain principles and operations of the various embodiments. As such, the disclosure will become more fully understood from the following Detailed Description, taken in conjunction with the accompanying Figures, in which:

FIG. 1 is a schematic diagram from a side sectional perspective of an optical fiber connector.

FIGS. 2-6 are schematic diagrams from side sectional perspectives of ferrules according to various exemplary embodiments.

FIG. 7 is a schematic diagram from a side sectional perspective of a multi-fiber ferrule according to an exemplary embodiment.

### DETAILED DESCRIPTION

Before turning to the following Detailed Description and Figures, which illustrate exemplary embodiments in detail, it should be understood that the present innovative and inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

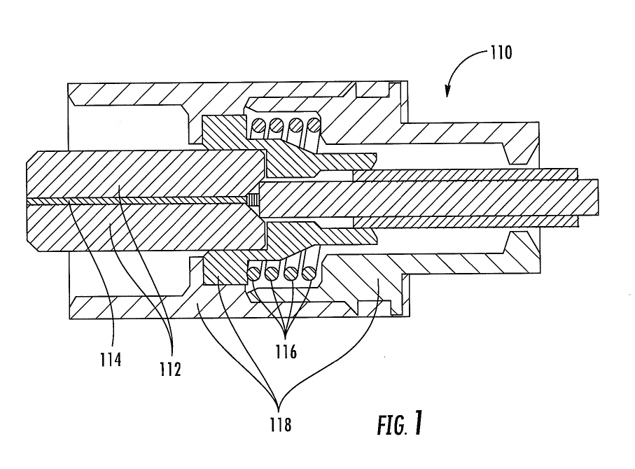

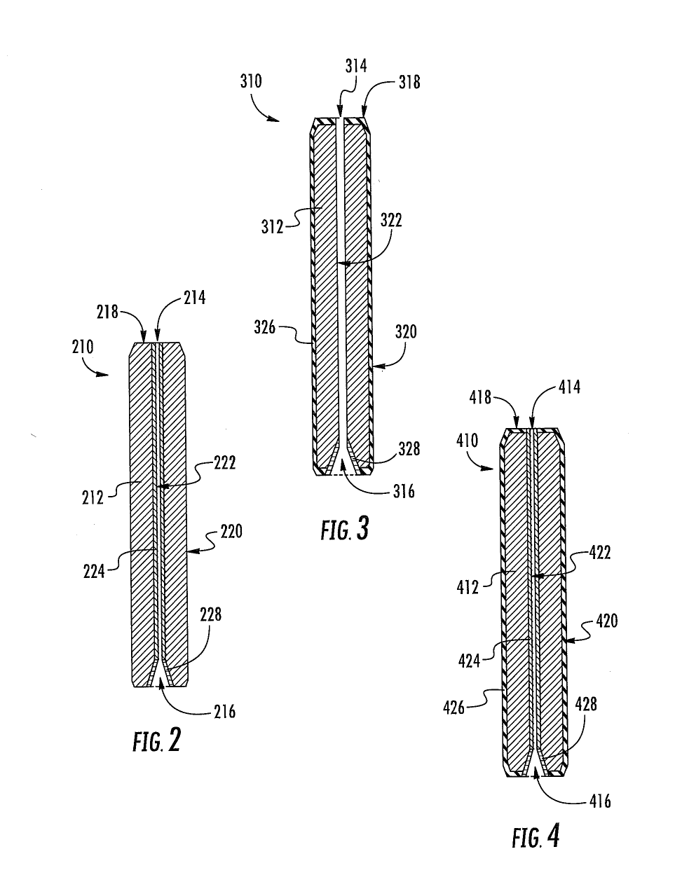

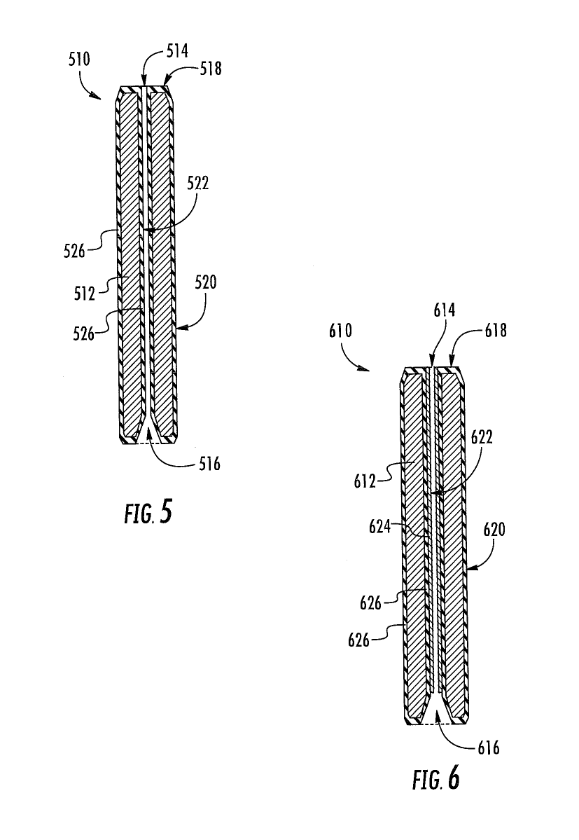

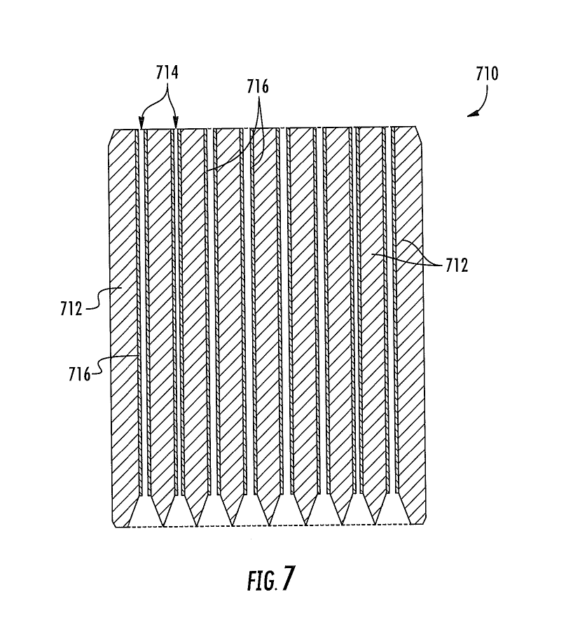

More specifically describing the exemplary embodiments of the Figures, FIG. 1 is a schematic illustration from a side sectional perspective of an optical fiber connector plug 110 including a fiber 114, a ferrule 112, a coil spring 116, and housing components 118, among other components. FIG. 2 is a schematic diagram from a side sectional perspective of a ferrule 210 that includes a dense body 212 having low coefficient of thermal expansion (CTE), high strength, and intrinsically high wear and impact resistance; a central bore 214 having a flared opening 216 at its proximal end; a front face surface 218; an exterior side surface 220; a central bore surface 222; a layer of silica or silica-rich material 224 comprising the central bore surface 222; and optionally a surface layer 228 comprising an extension of layer 224 into the flared proximal end of the bore 216, according to an exemplary embodiment. FIG. 3 is a schematic diagram from a side sectional perspective of a ferrule 310 that includes a dense, low-CTE body 312; a central bore 314 having a flared opening 316 at its proximal end; a front face surface 318; an exterior side surface 320; a central bore surface 322; a wear- and impact-resistant surface layer 326 having a different composition from the ferrule body 312 and comprising the exterior surface 320 of the ferrule 310; and optionally a surface layer 328 comprising an extension of layer 326 into the flared proximal end of the bore 316, according to still another exemplary embodiment. FIG. 4 is a schematic diagram from a side sectional perspective of a ferrule 410 that includes a dense, low-CTE body 412; a central bore 414 having a flared opening 416 at its proximal end; a front face surface 418; an exterior side surface 420; a central bore surface 422; a layer of silica or silica-rich material 424 comprising the central bore surface 422; a wear- and impact-resistant surface layer 426 having a different composition from the ferrule body 412 and comprising the exterior surface 420 of the ferrule 410; and optionally a surface layer 428 comprising an extension of either layer 424 or 426 into the flared proximal end of the bore 416, according to another exemplary embodiment. FIG. 5 is a schematic diagram from a side sectional perspective of a ferrule 510 that includes a dense, low-CTE body 512; a central bore 514 having a flared opening 516 at its proximal end; a front face surface 518; an exterior side surface 520; a central bore surface 522; a wear- and impact-resistant silica or silica-rich surface layer 526 having a different composition from the ferrule body 512 and comprising the exterior surface 520 of the ferrule 510 and further extending into the flared proximal end of the bore 516 and still further forming a layer 526 in the central bore 514, according to yet another exemplary embodiment. FIG. 6 is a schematic diagram from a side sectional perspective of a ferrule 610 that includes a dense, low-CTE body 612; a central bore 614 having a flared opening 616 at its proximal end; a front face surface 618; an exterior side surface 620; a central bore surface 622; a layer of silica or silica-rich material 624 comprising the central bore surface 622; a wear- and impact-resistant surface layer 626 having a different composition from the ferrule body 612 and comprising the exterior surface 620 of the ferrule 610 and further extending into the flared proximal end of the bore 616 and still further forming a layer underlying the layer of silica or silica-rich material 624 in the central bore 614 according to another exemplary embodiment. FIG. 7 is a schematic diagram from a side sectional perspective of a multi-fiber ferrule 710 having a body 712 with bores 714 lined with a layer 716 according to an exemplary embodiment.

Referring now to FIGS. 1-6, a ferrule 210, 310, 410, 510, 610 (see generally ferrule 112 in FIG. 1 showing integration of such a ferrule in a connector plug 110; see also ferrule 710 as shown in FIG. 7 configured for a multi-fiber connector), for use in an optical waveguide connector assembly, includes a main body 212, 312, 412, 512, 612 of the ferrule 210, 310, 410, 510, 610 having material including a glass, a glass-ceramic, a ceramic, a cermet, and/or a metal silicide where the coefficient of thermal expansion (CTE) of the material is less than 60×10⁻⁷° C.⁻¹. When the ferrule body 212, 412, 512, 612 does not include a silica-rich material that can be directly thermally bonded to the optical fiber (see, e.g., optical fiber 114 of ferrule 112 as shown in FIG. 1), the ferrule 210, 410, 510, 610 may then further include a thin layer 224, 424, 526, 624 of another material on the interior surface 222, 422, 522, 622 of the bore 214, 414, 514, 614 of the ferrule 210, 410, 510, 610 where the other material includes a silica or silica-rich phase. In some embodiments, the ferrule, 310, 410, 510, 610 may still further include another thin surface layer 326, 426, 526, 626 of glass, glass-ceramic, or ceramic having high wear resistance, which comprises the exterior surface 320, 420, 520, 620 of the ferrule, 310, 410, 510, 610. The ferrule 112 in FIG. 1 may be replaced by any of the embodiments disclosed herein, including the ferrules 210, 310, 410, 510, 610 shown in FIGS. 2-6.

The low CTE of the main body 212, 312, 412, 512, 612 of material, which includes the majority of the volume of the ferrule 210, 310, 410, 510, 610, is advantageous for providing an increased thermal shock resistance to the ferrule 210, 310, 410, 510, 610 thereby minimizing damage to the front face 218, 318, 418, 518, 618 of the ferrule 210, 310, 410, 510, 610 during cutting and thermal polishing of the end of the fiber (e.g., optical fiber 114 of ferrule 112 as shown in FIG. 1) by a focused energy source, such as a laser. The low CTE of the main body 212, 312, 412, 512, 612 also may reduce stresses and strains within a low-expansion optical fiber itself, as well as at an interfacial bond between the fiber and the interior bore surface 222, 322, 422, 522, 622 of the ferrule 210, 310, 410, 510, 610, which may arise from temperature changes occurring during or after processing steps whereby the fiber is bonded to the ferrule 210, 310, 410, 510, 610, or from temperature changes to which the fiber and ferrule 210, 310, 410, 510, 610 are subjected during the operational lifetime of the interconnect. In at least some preferred embodiments, the CTE of the material of the main body 212, 312, 412, 512, 612 is not more than 40×10⁻⁷° C.⁻¹, and even more preferably not more than 35×10⁻⁷° C.⁻¹, 30×10⁻⁷° C.⁻¹, 25×10⁻⁷° C.⁻¹, and/or even not more than 20×10⁻⁷° C.⁻¹. However, in other contemplated embodiments, materials with other CTEs may be used.

In some embodiments, the main body 212, 312, 412, 512, 612 of the ferrule 210, 310, 410, 510, 610 includes a low-CTE ceramic or cermet or silicide material, which possesses a high thermal conductivity. Accordingly, such a material preferably contains minimal amounts of a glass phase or of impurities dissolved within the crystal lattice of the ceramic phase(s). A high thermal conductivity is advantageous for dispersal of heat that may be generated locally by use of a focused energy source, such as a laser, during the cutting, bonding, and thermal polishing of the fiber (e.g., optical fiber 114 of ferrule 112 as shown in FIG. 1) within the ferrule 210, 310, 410, 510, 610. In some preferred embodiments the thermal conductivity of the material of the main body 212, 312, 412, 512, 612 of the ferrule 210, 310, 410, 510, 610 is at least 3 W/(m·K), 4 W/(m·K), 5 W/(m·K), and/or even at least 6 W/(m·K). In some preferred embodiments, the thermal conductivity of the ferrule body 212, 312, 412, 512, 612 is at least 10 W/(m·K) and even at least 20, 30, 40, and at least 50 W/(m·K).

In some embodiments, the wear- and impact-resistant exterior surface 220, 320, 420, 520, 620 and wear- and impact-resistant front face 218, 318, 418, 518, 618 of the ferrule 210, 310, 410, 510, 610 includes a low-CTE ceramic or cermet or silicide material, which possesses a high thermal conductivity. Accordingly, such a material preferably contains minimal amounts of a glass phase or of impurities dissolved within the crystal lattice of the crystalline phase(s). A high thermal conductivity is advantageous for dispersal of heat that may be generated locally by use of a focused energy source, such as a laser, during the cutting, bonding, and/or thermal polishing of the fiber within the ferrule 210, 310, 410, 510, 610. In some preferred embodiments the thermal conductivity of the material of the surface of the ferrule 210, 310, 410, 510, 610 is at least 3 W/(m·K), 4 W/(m·K), 5 W/(m·K), and/or even at least 6 W/(m·K). In some preferred embodiments, the thermal conductivity of the surface of the ferrule 210, 310, 410, 510, 610 is at least 10 W/(m·K) and even at least 20, 30, 40, and at least 50 W/(m·K). In some such embodiments, the body 212, 312, 412, 512, 612 of the ferrule 210, 310, 410, 510, 610 and the surface of the ferrule 210, 310, 410, 510, 610 have thermal conductivity as described, where the body 212, 312, 412, 512, 612 and surface may be formed from the same or different materials or combinations of material components (compare ferrule 210 of FIG. 2, where body 212 extends to the outer surface, with ferrule 310 of FIG. 3, where body 312 is encased with layer 326 forming the outer surface).

Use of a glass-ceramic as the body 212, 312, 412, 512, 612 of the ferrule 210, 310, 410, 510, 610 may be advantageous in some embodiments because the ferrule 210, 310, 410, 510, 610 is then pore-free from its inception and can be pre-formed with an axial bore 214, 314, 414, 514, 614 by drawing the glass as a tubing, and cutting the tubing into segments. Subsequent ceramming of the glass then yields a material with greater strength, lower CTE, and greater thermal conductivity than a glass ferrule.

Wear resistance of the surface of the ferrule 210, 310, 410, 510, 610 provides mechanically and tribologically durable interfaces 218, 318, 418, 518, 618, and 220, 320, 420, 520, 620, which can withstand multiple coupling and decoupling of the ferrule 210, 310, 410, 510, 610 with the adapter sleeve of the connector assembly. In some embodiments, ceramic of the ferrule 210 (e.g., material forming the main body 212) intrinsically possesses a high strength and high impact- and wear-resistance, in which case the ferrule may not require additional wear-resistant exterior surface layer(s) (e.g., layer 326 as shown in FIG. 3), and only possesses a silica or silica-rich layer 224 on the interior surface 222 of the bore 214 (see generally ferrule 210 of FIG. 2).

Referring to FIGS. 3 to 6, the ferrule 310, 410, 510, 610 possesses an additional wear- and impact-resistant surface layer 326, 426, 526, 626. The wear resistance of the surface of the ferrule may be provided by a surface compressive layer, that is, a surface layer 326, 426, 526, 626 that exists in a state of compression under ambient use conditions. The compressive surface layer not only increases the strength of the ferrule 310, 410, 510, 610, but also provides higher fracture toughness which is advantageous for wear resistance, especially under conditions of sliding contact. Alternatively, the wear resistance of the surface of the ferrule 310, 410, 510, 610 may be provided by a thin layer 326, 426, 526, 626 of a material having a high hardness and/or high fracture toughness but which is not necessarily in a compressive state. In both cases, the thickness of the wear-resistant surface layer 326, 426, 526, 626 is preferably at least 5 μm, 10 μm, 20 μm, 30 μm, 40 μm, and even 50 μm in order to provide high resistance to the inward propagation of surface flaws. When the surface layer 326, 426, 526, 626 is in a substantially compressive state, it is preferably not greater than 400 μm, 300 μm, 200 μm, and even 150 μm in order to maximize the compressive stress in the surface and minimize the tensile stresses in the underlying body 312, 412, 512, 612 of the ferrule 310, 410, 510, 610.

In some embodiments, the surface layer 326, 426 may optionally extend into the flared proximal opening 316, 416 of the central bore 314, 414 of the ferrule 310, 410 to form a surface layer 328, 428. In some cases, a silica or silica-rich layer 424, which may be independent of the wear-resistant layer 426, may be provided on the interior surface 422 of the bore 414 of the ferrule 410 (FIG. 4). The silica or silica-rich layer 424 may optionally extend into the flared proximal opening 416 of the central bore 414 of ferrule 410 to form a layer 428 on the flared opening 416.

In other embodiments, the wear-resistant layer 526, 626 may further extend into the central bore 514, 614 of the ferrule 510, 610 (FIGS. 5 and 6). In cases where the wear-resistant layer comprises a silica or silica-rich material, the layer 526 within the bore 514 of the ferrule 510 provides a material to which the predominantly silica optical fiber (e.g., optical fiber 114 as shown in FIG. 1) can be readily bonded thereto. Thus, the wear-resistant surface layer 526 and the silica-rich layer 526 desired for direct bonding of the fiber are one and the same in some such embodiments (FIG. 5). In cases where the wear-resistant layer 626 does not comprise a silica or silica-rich material, an additional layer of silica or silica-rich material 624 may be provided on the surface of the central bore 614 of the ferrule 610 to provide a material to which the predominantly silica optical fiber can be readily bonded thereto (FIG. 6). Use of the wear-resistant surface layer 626 beneath the silica or silica-rich layer 624, as shown in FIG. 6, may allow for application of the latter in higher-stress conditions of the ferrule 610, such as via high-temperature deposition methods, thereby mitigating likelihood of damage to the ferrule 610 during the application.

In accordance with embodiments in which the wear-resistant surface includes a surface layer 326, 426, 526, 626 that is under compression, the surface compressive layer 326, 426, 526, 626 may include a material having a CTE that is less than that of the main body 312, 412, 512, 612 of the ferrule 310, 410, 510, 610. In one type of embodiment, the low-CTE surface layer 326, 426, 526, 626 may be formed on top of the pre-existing surface of the ferrule core (i.e. body 312, 412, 512, 612) by coating processes known in the art, such as especially dip coating, chemical vapor deposition, and physical vapor deposition, although plasma spraying, flame spraying, co-extrusion, cladding, and others may also be used.

Alternatively, in other embodiments, the surface layer 326, 426, 526, 626 may be formed from the main body 312, 412, 512, 612 of the ferrule 310, 410, 510, 610 itself by chemically modifying the surface of the main body 312, 412, 512, 612 through the replacement of one or more cations or anions in the predominant phase of the ferrule 310 material with one or more cations or anions which, when substituted into the predominant amorphous or crystalline phase of the core material (i.e. material of the main body 312, 412, 512, 612), produce a new material near the surface 326, 426, 526, 626 which has a lower CTE than that of the original main body 312, 412, 512, 612 material. In such embodiments, the chemically modified predominant phase of the new material 326, 426, 526, 626 will typically be crystallographically isostructural with the predominant phase of the material that comprises the body 312, 412, 512, 612 of the ferrule 310, 410, 510, 610.

In still other embodiments, the pre-existing surface of the main body 312, 412, 512, 612 is reacted with one or more substances and thereby partially consumed so as to produce one or more new phases as a surface layer 326, 426, 526, 626 on the ferrule 310, 410, 510, 610 such that the surface composition 326, 426, 526, 626 has a lower CTE than the body 312, 412, 512, 612.

In all three cases of embodiments just described, once the surface layer 326, 426, 526, 626 has been created, the ferrule 310, 410, 510, 610 may be heated to a high temperature to fully densify and anneal the surface layer 326, 426, 526, 626 to a stress-free state, after which the composite ferrule 310, 410, 510, 610 is then cooled to room temperature at a rate that is as fast as practical without damaging the ferrule 310, 410, 510, 610. The lower CTE of the surface layer 326, 426, 526, 626 causes it to undergo less shrinkage than the body 312, 412, 512, 612 of the ferrule 310, 410, 510, 610 during the cooling process, thereby placing the surface in a state of compression. It is anticipated that this compressive layer 326, 426, 526, 626 will increase the strength and thermal shock resistance of the ferrule 310, 410, 510, 610 and provide a wear-resistant surface by means of the higher strength and higher fracture toughness of the surface. Rapid cooling of the composite ferrule 310, 410, 510, 610 after annealing of the surface layer 326, 426, 526, 626 is expected to provide a greater compressive stress in the surface by minimizing the time during which stresses can be relaxed during cooling in the higher-temperature portion of the cooling cycle. In some embodiments it is preferred that the difference between the CTE of the surface layer 326, 426, 526, 626 and that of the body 312, 412, 512, 612 of the ferrule 310, 410, 510, 610 is at least 10×10⁻⁷° C., 20×10⁻⁷° C., 30×10⁻⁷° C., 40×10⁻⁷° C., and even at least 50×10⁻⁷° C. In some methods of the preferred embodiments, the temperature at which the surface layer 326, 426, 526, 626 (e.g., coating) is annealed is at least 700° C., 800° C., 900° C., 1000° C., 1100° C., and even at least 1200° C.

Referring to FIG. 5, in at least one preferred embodiment, the compressive, wear-resistant surface layer 526 includes dense, amorphous or glassy silica. The low CTE of the glassy silica, approximately 6×10⁻⁷° C.⁻¹, enables formation of a compressive layer 526 for a wide selection of ferrule body 512 materials having CTEs greater than about 10×10⁻⁷° C.⁻¹. Furthermore, this compressive amorphous silica layer 526, when also present on the walls of the central bore 526 in the ferrule 510, provides a material to which the predominantly silica optical fiber (e.g., optical fiber 114 as shown in FIG. 1) can be readily bonded thereto. Thus, the wear-resistant surface layer 526 and the silica-rich layer 526 desired for direct bonding of the fiber are one and the same in some such embodiments (FIG. 5).

Referring generally to FIGS. 3-6, in other embodiments in which the surface layer 326, 426, 526, 626 is under compression, the compressive surface layer 326, 426, 526, 626 of the ferrule 310, 410, 510, 610 is provided by chemically modifying the surface and sub-surface material of the body 312, 412, 512, 612 of the ferrule 310, 410, 510, 610 such that the chemically-modified material would, if in an unconstrained and stress-free environment, occupy a greater volume than the original core material (i.e., material of the body 312, 412, 512, 612), that is, the modified surface material 326, 426, 526, 626 would possess a greater molar volume. This chemical modification may be achieved by replacing one or more type of cation or anion in the near-surface region of the body 312, 412, 512, 612 of the ferrule 310, 410, 510, 610 with one or more type of cation or anion having a larger ionic radius than the cation(s) or anion(s) being replaced. The larger ions cause the near-surface region to expand, thereby placing the surface under compression. The exchange of ions may be achieved, for example, by placing the ferrule 310, 410, 510, 610 in a molten salt bath for a sufficient time to develop a sufficient gradient in composition to produce the desired magnitude of surface compression and wear and impact resistance.

In some embodiments it is preferred that the relative increase in linear dimension, ΔL/L, between the surface layer 326, 426, 526, 626 and the body 312, 412, 512, 612 of the ferrule 310, 410, 510, 610 is at least 0.004, 0.006, 0.008, 0.010, 0.012, 0.014, 0.016, 0.018, and even at least 0.020. The value of ΔL/L may be calculated from the ratio of the molar volume of the surface layer 326, 426, 526, 626, Vₛ, to the molar volume of the body 312, 412, 512, 612 of the ferrule 310, 410, 510, 610, V_{b}, according to the relation ΔL/L=(Vₛ/V_{b})^{1/3}−1. When the body 312, 412, 512, 612 and surface layer 326, 426, 526, 626 materials are each substantially a single crystalline phase, and when the crystalline phase of the surface layer 326, 426, 526, 626 is isostructural with that of the body 312, 412, 512, 612, then the ratio of the molar volumes may be substituted by the ratio of the unit cell volumes of the predominantly single phases of the body 312, 412, 512, 612 and the surface layer 326, 426, 526, 626. In this case, the unit cell volumes of the two isostructural phases must be based upon the same number of atomic sites per unit cell. In materials that are comprised of more than one phase, the molar volume of the multi-phase “bulk” material, V_{b}, is computed as V_{b}=V₁m₁+V₂m₂+ . . . Vⱼmⱼ, in which Vᵢ is the molar volume of phase “i”; and mᵢ is the mole fraction of phase “i” in the multiphase material.

In some embodiments, it is preferred that the wear-resistant layer 326, 426, 526, 626 on the exterior of the ferrule 310, 410, 510, 610 has a Vickers hardness of at least 10 Gpa, and more preferably at least 12 Gpa, 15 Gpa, and even at least 20 Gpa. It is further preferred that the wear-resistant layer 326, 426, 526, 626 on the exterior of the ferrule 310, 410, 510, 610 has a fracture toughness of at least 5 Mpa m^{1/2}, and more preferably at least 6 Mpa m^{1/2}, 7 Mpa m^{1/2}, 8 Mpa m^{1/2}, 9 Mpa m^{1/2}, and even 10 Mpa m^{1/2}. In other embodiments it is preferred that the wear-resistant layer 326, 426, 526, 626 on the exterior of the ferrule 310, 410, 510, 610 have a compressive stress of at least 200 Mpa, and more preferably at least 400 Mpa, 600 Mpa, 800 Mpa, 1000 Mpa, and even at least 1200 Mpa.

### EXAMPLES

In accordance with the present disclosure, various combinations of core (e.g., body 312, 412, 512, 612) and surface (e.g., layer 326, 426, 526, 626) materials are provided as examples, along with various methods of making those combinations. Aspects or features of one such example may be combined or substituted for aspects or features of other such examples as within the ability of one of skill in the art.

### Examples Based Upon a Surface Compressive Layer Having a Lower CTE than the Core

Table 1 (below) provides examples of some materials having coefficients of thermal expansion less than about 60×10⁻⁷° C.⁻¹. The CTEs, in Table 1 and in the other tables, are mean CTEs from room temperature to a temperature of between 800 to 1000° C., that is: CTE=((L_{T}−L_{To})/L_{To})/(T−Tₒ), in which “Tₒ” is room temperature, “T” is about 900° C. (e.g., 900° C.±100° C.; a temperature between 800 and 1000° C.), “L_{To}” is the length of a specimen of the material at Tₒ and “L_{T}” is the length of a specimen of the material at T. It will be recognized that other materials having a CTE less than about 60×10⁻⁷° C.⁻¹ exist and are not listed in the table for the sake of brevity, and the present disclosure is not limited to only the examples provided.

TABLE 1
Coefficients of thermal expansion of materials considered as
ferrule bodies and/or compressive surface layers in examples
of the present innovative and inventive technology.

| Material | | CTE |
|---|---|---|
| Number | Material Composition | (10⁻⁷ ° C.⁻¹) |
| 1 | Zr₂P₂WO₁₂ | −29 |
| 2 | RbZr₂P₃O₁₂ | −10 |
| 3 | KZr₂P₃O₁₂ | −9 |
| 4 | β-spodumene | −1 to +6 |
| 5 | β-eucryptite | 2 to 4 |
| 6 | Ta₂WO₈ | 5 |
| 7 | Fused silica | 6 |
| 8 | Ta₁₆W₁₈O₉₄ | 14 |
| 9 | LiZr₂P₃O₁₂ | 15 |
| 10 | CaZr₄P₆O₂₄ | 15 |
| 11 | Na_{0.25}Mg₂Al_{4.25}Si_{4.75}O₁₈ | 15 |
| 12 | Mg₂Al₄Si₅O₁₈ | 17 |
| 13 | CsMg₂Al₅Si₄O₁₈ | 22 |
| 14 | RbTi₂P₃O₁₂ | 23 |
| 15 | Ta₂O₅ | 24 |
| 16 | BaMg₂Al₆Si₉O₃₀ | 26 |
| 17 | KTi₂P₃O₁₂ | 26 |
| 18 | Na₂Mg₅Si₁₂O₃₀ | 27 |
| 19 | SrZr₄P₆O₂₄ | 29 |
| 20 | BaTi₄P₆O₂₄ | 29 |
| 21 | CsAlSi₂O₆ | 32 |
| 22 | Si₃N₄ | 32 |
| 23 | Si₂N₂O | 32 |
| 24 | β′-Sialon (Si—Al—O—N compound) | 35 |
| 25 | BaZr₄P₆O₂₄ | 35 |
| 26 | Zn₂SiO₄ | 36 |
| 27 | Ta₂₂W₄O₆₇ | 36 |
| 28 | HfSiO₄ | 38 |
| 29 | Cs₂MgSi₅O₁₂ | 38 |
| 30 | LiNaTiSi₆O₁₅ | 39 |
| 31 | Ta₃₀W₂O₈₁ | 40 |
| 32 | SiC | 40 |
| 33 | BaTiSi₃O₉ | 42 |
| 34 | SrAl₂Si₂O₈ (Sr-celsian) | 42 |
| 35 | BaAl₂Si₂O₈ (celsian) | 44 |
| 36 | CaAl₂Si₂O₈ | 45 |
| 37 | NaZr₂P₃O₁₂ | 46 |
| 38 | ZrSiO₄ | 47 |
| 39 | K₂Mg₅Si₁₂O₃₀ | 49 |
| 40 | Al₆Si₂O₁₃ | 55 |
| 41 | LiNaZrSi₆O₁₅ | 55 |

As examples, any of the materials numbered 2-41 in Table 1 are contemplated for use as a material of the main body 212, 312, 412, 512, 612, 712 of the ferrule 210, 310, 410, 510, 610, 710. When the thin surface layer 326, 426, 526, 626 of the ferrule 310, 410, 510, 610 includes a lower-CTE material that is under a compressive stress, that material may be selected from material numbered 1-40 in Table 1, such that the CTE of the thin surface layer 326, 426, 526, 626 is less than that of the core material of the main body 312, 412, 512, 612. The difference in CTE between the surface layer 326, 426, 526, 626 and core body 312, 412, 512, 612 materials, ΔCTE, is preferably at least 10×10⁻⁷° C.⁻¹. The compressive stress in the surface layer 326, 426, 526, 626 of the ferrule 310, 410, 510, 610, σₛ, may be estimated from the relation:

σₛ=E(ΔCTE)(ΔT)/(1−ν), in which E is the Young's elastic modulus of the surface layer 326, 426, 526, 626, ΔCTE is the difference between the CTE of the ferrule body 312, 412, 512, 612 and that of the surface layer 326, 426, 526, 626, ΔT is the difference in temperature between the temperature at which the thin layer 326, 426, 526, 626, on the exterior of the ferrule was annealed and room temperature in Celsius or Kelvin, and ν is the Poisson's ratio of the surface layer 326, 426, 526, 626. Thus, for example, the compressive stress in a thin layer 326, 426, 526, 626 of fused silica (material 7 in Table 1) on a ferrule body 312, 412, 512, 612 of pollucite, CsAlSi₂O₆ (material 21 in Table 1) may be estimated by taking E=10×10⁶ psi, ν=0.17, ΔT=1000° C., and Δα=26×10⁻⁷° C.⁻¹, whereby σₛ=(10×10⁶)(26×10⁻⁷)(1000)/(1−0.17)=31325 psi (216 MPa).

Examples of at least some preferred material combinations from Table 1 include those in which the compressive surface layer 326, 426, 526, 626 includes a β-spodumene ceramic or glass-ceramic, a β-eucryptite ceramic or glass-ceramic, amorphous (“fused” or “glassy”) silica, or other glass or glass-ceramic having a CTE of not greater than 25×10⁻⁷° C.⁻¹, and preferably not greater than 10×10⁻⁷° C.⁻¹, and in which the main body 312, 412, 512, 612 of the ferrule 310, 410, 510, 610 comprises a ceramic or glass-ceramic based upon one or more of Mg₂Al₄Si₅O₁₈ (cordierite), a so-called “stuffed cordierite” containing an alkali or alkaline earth such as Na_{0.25}Mg₂Al_{4.25}Si_{4.75}O₁₈ (sodium-stuffed cordierite) or CsMg₂Al₅Si₄O₁₈ (cesium-stuffed cordierite), any other orthorhombic or hexagonal phase having the cordierite crystal structure, BaMg₂Al₆Si₉O₃₀ (barium osumilite), Na₂Mg₅Si₁₂O₃₀ (sodium roedderite), CsAlSi₂O₆ (pollucite), Si₃N₄ (silicon nitride), Si₂N₂O (silicon oxynitride), β′-sialon, Zn₂SiO₄ (willemite), Cs₂MgSi₅O₁₂, or SiC (silicon carbide). Core materials of the main body 312, 412, 512, 612 with even higher CTEs may provide a surface layer 326, 426, 526, 626 with greater compressive stresses, although in some instances such composites may have a lower thermal shock resistance and their CTE will not be as closely matched to that of the optical fiber (see, e.g., optical fiber 114 as shown in FIG. 1). The core material of the main body 312, 412, 512, 612, 712 may optionally include a glass having a CTE of about 10-50×10⁻⁷° C.⁻¹. In such embodiments, the CTE of the glass comprising the main body 312, 412, 512, 612, 712 is preferably not more than 40×10⁻⁷° C.⁻¹, 30×10⁻⁷° C.⁻¹, and even not more than 20×10⁻⁷° C.⁻¹.

Examples of some other preferred material combinations from Table 1 include those in which the compressive surface layer 426, 626 includes Zr₂P₂WO₁₂, RbZr₂P₃O₁₂, or KZr₂P₃O₁₂, and the body 412, 612 of the ferrule 410, 610 includes LiZr₂P₃O₁₂, CaZr₄P₆O₂₄, RbTi₂P₃O₁₂, KTi₂P₃O₁₂, SrZr₄P₆O₂₄, BaTi₄P₆O₂₄, or BaZr₄P₆O₂₄, and their crystalline solutions.

The low-CTE surface material may be produced by methods described above. When the ferrule body 312, 412, 512, 612 material is initially formed as a glass and is later converted into a glass-ceramic by a crystallization heat treatment, such heat treatment may be performed prior to the formation of the surface layer 326, 426, 526, 626 material. Alternatively, in some cases the surface layer 326, 426, 526, 626 may be formed on the glass core, and the composite article is then provided a heat treatment to ceram the core material, after which the article may optionally be taken to a still higher temperature to fully densify and anneal the surface layer 326, 426, 526, 626 and subsequently cooled to room temperature. In still other cases in which the ferrule body 312, 412, 512, 612 is to be converted to a glass-ceramic, the surface layer 326, 426, 526, 626 may be consolidated or crystallized at one temperature, and the glass body of the ferrule is cerammed at a still higher temperature. The final temperature to which the ferrule body 312, 412, 512, 612 and surface layer 326, 426, 526, 626 are heat treated should be maximized and the cooling rate should be as rapid as practical in order to maximize the compressive stress in the surface layer 326, 426, 526, 626.

When the surface layer 326, 526 includes glassy silica, the silica layer 326, 526 may be applied on top of the pre-existing surface of the core (i.e., body 312, 512) such as by chemical vapor deposition (CVD), physical vapor deposition (PVD), soot deposition, dip coating in a solution or suspension of silica or a silica-forming precursor or a silicon organometallic liquid, cladding of the core material with a silica glass, co-extrusion of the core and surface components from particulate raw materials and co-sintering the article to full density, and other methods. For certain materials of the main body 312, 512 of the ferrule 310, 510, including a silicate glass, glass-ceramic, or ceramic, it is conceived that the main body 312, 512 may be subjected to leaching of the non-silica components in an acid solution such that the surface of the core is converted to a porous layer including predominantly silica. This layer may optionally be impregnated with additional silica from a source, such as a suspension, solution, or other liquid bearing a silica precursor; or may be impregnated with a small amount of a fluxing agent, such as a B₂O₃ source, that promotes consolidation of the silica layer at reduced temperatures. The ferrule 310, 510 is subsequently heated to consolidate the surface to a dense glassy silica-rich layer 326, 526 at high temperature, such as at 900-1100° C. If the ferrule body 312, 512 material includes a glass that is to be converted into a glass-ceramic, the ceramming step may be provided prior to, concurrent with, or even following the densification of the silica layer. The alkali and alkaline earth silicates and aluminosilicates listed in Table 1, which have a CTE of at least 10×10⁻⁷° C.⁻¹ are considered to be especially good candidates for production of the surficial silica layer by acid leaching followed by thermal annealing.

In at least some especially preferred embodiments, the main body 212, 312, 412, 512, 612 of the ferrule 210, 310, 410, 510, 610 may include a silicon carbide (SiC), silicon nitride (Si₃N₄), silicon oxynitride (Si₂N₂O), or β′-sialon ceramic having low CTE and possessing one or more of high strength, high toughness, and high thermal conductivity. A silica layer 224, 526 may be formed on the interior bore surface 222, 522 and optionally the exterior surface 520 of the ferrule by a coating technique or may be formed by oxidation of the surface of the ceramic at high temperatures in an oxygen-containing atmosphere such as air. In the case of silicon nitride and β′-sialon, which are known to have a low CTE, high hardness, high toughness, high strength, a low coefficient of friction, and in some instances a high thermal conductivity, the external surface of the ferrule 210, 510 may optionally be polished after coating to re-exposed the underlying ceramic, leaving a silica layer 224 only in the bore of the ferrule 210 to facilitate bonding of the fiber (see, e.g., optical fiber 114 as shown in FIG. 1). Alternatively, a silica or silica-rich coating 224, 716 may be applied only to the surface of the bore 214, 714 of the ferrule 210, 710, as shown in FIGS. 2 and 7.

In another especially preferred example, the main body 312, 512 of the ferrule includes Mg₂Al₄Si₅O₁₈ (cordierite or indialite) or a Mg₂Al₄Si₅O₁₈-based solid solution and the compressive surface 326, 526 includes a glassy silica. Depending upon the degree of Al/Si ordering in the crystal structure and nature of any cations that may be substituted for Mg, Al, or Si or that may be present in the normally vacant “channel” sites in the cordierite crystal structure, the CTE of the ferrule body 312, 512 may be adjusted to lie between about 12 and 22×10⁻⁷° C.⁻¹. Addition of a second phase (crystalline or amorphous) having a higher CTE may be used to increase the bulk CTE of the ferrule core (i.e., body 312, 512), which would increase the magnitude of the compressive stress in the silica surface layer 326, 526. In some such embodiments, the cordierite may be formed as a ceramic such as by the extrusion or injection molding of a mixture of simple or complex natural or synthetic metal oxide powder raw materials that react to form cordierite at high temperature. Alternatively, the powder raw materials may include pre-reacted cordierite or a magnesium aluminosilicate-based glass powder which devitrifies, or cerams, to a predominantly cordierite body at high temperature. According to such an embodiment, the polycrystalline cordierite ceramic or glass-ceramic preferably has less than 5% porosity and more preferably less than 1% porosity after sintering. The cordierite may also be formed by first melting the cordierite-forming raw materials and subsequently forming a shape and cooling the shape to a glass. The shape may be the final or near-final shape of the ferrule 310, 510 or it may be subsequently machined to the desired shape. In some embodiments, the glass body is heated to a temperature sufficient to devitrify the glass into a predominantly cordierite-phase glass-ceramic.

According to an exemplary embodiment, the silica layer 326, 526 may be applied to the cordierite or pre-cordierite ferrule by any of various means. For example, the fully or near-fully dense cordierite or glass body, in the shape of the final ferrule article, could be immersed in an acidic solution at a temperature and for a time sufficient to remove most of the magnesium and aluminum from the surface, leaving a porous layer consisting mostly of silica. The body 312, 512 would then be heated to a temperature sufficient to densify the silica layer 326, 526 but below the temperature of cristobalite formation. If the ferrule body 312, 512 was initially a glass, then the glass could also be cerammed during this heat treatment cycle. Upon cooling to room temperature, the lower CTE of the silica layer relative to the cordierite body would put the surface into compression. Alternatively, the silica layer 326, 526 could be applied by dip coating the cordierite or pre-cordierite glass ferrule in a solution of colloidal silica, or emulsion or solution of a silicon organometallic resin or other liquid silica-forming precursor, drying the article, and subsequently heating to consolidate the silica surface to a non-porous layer. The silica layer 326, 526 may also be deposited onto the surface of the ferrule 310, 510 by a physical or chemical vapor deposition method or by RF sputtering, for example. Another coating method could include co-extrusion of a rod or tube having a core of a cordierite or cordierite-forming precursor powder mixture and an outer cladding (and optionally inner lining if tube-shaped) of a fused-silica glass powder, optionally containing sintering aids, and subsequently cutting the extruded rod or tube to desired lengths and firing these pieces to a temperature sufficient to form a dense cordierite body and fused silica surface layer. Alternatively, a tube of cordierite precursor glass could be clad and lined with fused silica or a glass that is predominantly silica, the tube drawn to the desired diameter and then cut to the desired lengths, and pieces cerammed to form a cordierite glass-ceramic body.

For certain materials of the main body 312, 412, 512, 612 of the ferrule 310, 410, 510, 610 containing exchangeable cations, a surface layer 326, 426, 526, 626 may be formed having a lower CTE than the body by the exchange of an appropriate alkali or alkaline earth ion into the surface of the core material. Examples of such core materials and their surface layers are provided in Table 2 (below). According to such embodiments, the change in the molar volume of the material at the surface due to ion exchange may be irrelevant, because the article (e.g., ferrule) could be taken to a sufficiently high temperature after ion-exchange so as to anneal the material and relieve all stresses. Upon cooling to room temperature, in some such embodiments, the surface develops a compressive stress due to its lower CTE relative to that of the core material which has undergone less, or no, ion exchange. In examples in which the ferrule body 312, 412, 512, 612 is to be made into a glass-ceramic, the ion-exchange may optionally be conducted on the glass article prior to the ceramming step in instances where this may facilitate the ion exchange process. Of the examples in Table 2, numbers 2.2, 2.3, and 2.4 are especially preferred. An additional silica or silica-rich layer 424, 624 may need to be provided to the surface 422, 622 of the bore 414, 614 of the ferrule 410, 610 to facilitate direct bonding of the fiber (see, e.g., optical fiber 114 as shown in FIG. 1) to the ferrule 410, 610. In other contemplated embodiments, a ferrule may include a compressive layer 326, 526 without an additional silica or silica-rich layer, and the fiber may be bonded to the bore via a bonding agent, such as epoxy. In other embodiments, the layer 326, 426, 526, 626 is not compressive, but may still protect the body 312, 412, 512, 612.

TABLE 2
Examples of ceramic ferrule body materials and surface compressive layers in
which the surface layer is formed by the exchange of an alkali or alkaline earth cation so as
to reduce the CTE of the surface layer and produce a compressive surface stress after
annealing at high temperature.

| | | CTE of | Surface | CTE of | Proposed method of forming |
|---|---|---|---|---|---|
| Ex. | Ferrule | body | compressive | surface | compressive layer specific to a given |
| No. | body material | (10⁻⁷ ° C.⁻¹) | layer material | (10⁻⁷ ° C.⁻¹) | core and surface combination |
| 2.1 | K₂Mg₅Si₁₂O₃₀ | 49 | Na₂Mg₅Si₁₂O₃₀ | 27 | Ion exchange of sodium for potassium |
| | ceramic or | | | | at surface, followed by ceramming if |
| | glass-ceramic | | | | glass, then annealing at high |
| | | | | | temperature |
| 2.2 | SrZr₄P₆O₂₄ | 29 | CaZr₄P₆O₂₄ | 15 | Ion exchange of calcium for strontium |
| | | | | | at surface followed by annealing at |
| | | | | | high temperature |
| 2.3 | BaZr₄P₆O₂₄ | 35 | CaZr₄P₆O₂₄ | 15 | Ion exchange of calcium for barium at |
| | | | | | surface followed by annealing at high |
| | | | | | temperature |
| 2.4 | LiZr₂P₃O₁₂ | 15 | KZr₂P₃O₁₂ or | −9 to −10 | Ion exchange of potassium or rubidium |
| | | | RbZr₂P₃O₁₂ | | for lithium at surface followed by |
| | | | | | annealing at high temperature |
| 2.5 | NaZr₂P₃O₁₂ | 46 | KZr₂P₃O₁₂ or | −9 to −10 | Ion exchange of potassium or rubidium |
| | | | RbZr₂P₃O₁₂ | | for sodium at surface followed by |
| | | | | | annealing at high temperature |
| 2.6 | NaZr₂P₃O₁₂ | 46 | LiZr₂P₃O₁₂ | 15 | Ion exchange of lithium for sodium at |
| | | | | | surface followed by annealing at high |
| | | | | | temperature |
| 2.7 | NaTi₂P₃O₁₂ | 47 | KTi₂P₃O₁₂ or | 23 to 26 | Ion exchange of potassium or rubidium |
| | | | RbTi₂P₃O₁₂ | | for sodium at surface followed by |
| | | | | | annealing at high temperature |
| 2.8 | CaTi₄P₆O₂₄ | 67 | BaTi₄P₆O₂₄ | 29 | Ion exchange of barium for calcium at |
| | | | | | surface followed by annealing at high |
| | | | | | temperature |
| 2.9 | SrTi₄P₆O₂₄ | 88 | CaTi₄P₆O₂₄ | 67 | Ion exchange of calcium for strontium |
| | | | | | at surface followed by annealing at |
| | | | | | high temperature |
| 2.10 | SrTi₄P₆O₂₄ | 88 | BaTi₄P₆O₂₄ | 29 | Ion exchange of barium for strontium |
| | | | | | at surface followed by annealing at |
| | | | | | high temperature |

### Examples Based Upon a Surface Compressive Layer Having a Larger Molar Volume than the Core

An alternative means for providing a compressive surface layer 326, 426, 526, 626 for enhanced strength and wear resistance, as included in some embodiments disclosed herein, is to exchange one or more type of cation or anion in the main body of the ferrule 310, 410, 510, 610 with a cation or anion having a larger ionic radius, thereby increasing the molar volume of the material at and near the surface of the main body 312, 412, 512, 612 and thus placing the surface under compression. Examples in which the ion-exchange of an alkali or alkaline earth cation in a low-CTE ceramic or glass-ceramic is anticipated to produce a compressive surface layer 326, 426, 526, 626 are presented in Table 3 (below). Included are the crystallographic unit cell volumes of the phases and the calculated ratios of the molar volumes of the surface layer 326, 426, 526, 626 materials divided by the molar volumes of the core (i.e., body 312, 412, 512, 612) materials. Thus, a value of V_{surface}/V_{core} of 1.046 represents a 4.6% increase in unit cell volume, and also molar volume, assuming complete ion exchange at the surface. The increase in linear dimension as expressed by the ratio L_{surface}/L_{core} may be calculated by taking the cube root of the value of V_{surface}/V_{core} for each example. Thus, for Ex. 3.1a, the increase in linear dimension would be L_{surface}/L_{core}=(1.046)^{(1/3)}=1.0151. The strain that corresponds to the increase in linear dimension is defined as ΔL/L, and is calculated as ΔL/L=(L_{surface}/L_{core})−1. In the case of Ex. 3.1a, the strain would be ΔL/L=0.0151. The corresponding compressive stress in the surface layer is approximately equal to E(ΔL/L)/(1−ν), where E is the elastic modulus of the surface layer and ν is the Poisson's ratio of the surface layer. Thus, for example, assuming E=10×10⁶ psi and ν=0.2, then the compressive surface stress for Ex. 3.1a would be (10×10⁶)(0.0151)/(1−0.2)=187130 psi (1290 MPa) for complete replacement of calcium by strontium at the surface. Some preferred examples include 3.4, 3.5, 3.6, 3.8, 3.10, 3.11 and 3.13 based upon the low CTE of the ferrule body 312, 412, 512, 612, 712. In some or all of the examples of Table 3, an additional silica or silica-rich layer 424, 624 may also have to be provided to the surface 422, 622 of the ferrule bore 414, 614 to enable direct bonding of the fiber (see, e.g., optical fiber 114 as shown in FIG. 1).

TABLE 3
Examples of combinations of ceramic core materials and surface compressive layers conceived
according to the present innovative and inventive technology in which compression of the surface
is achieved through a difference in molar volume following ion exchange

| | | Crystal | CTE of | | Crystal | |
|---|---|---|---|---|---|---|
| | | unit cell | body | | unit cell | Volume |
| Ex. | Ferrule | volume | material | Surface compressive | volume | increase, |
| No. | body material | (Å³) | (10⁻⁷ ° C⁻¹) | layer | (Å³) | V_{surface}/V_{core} |
| 3.1a | CaAl₂Si₂O₈ | 670.15 | 45 | SrAl₂Si₂O₈ | 700.7 | 1.0456 |
| 3.1b | | | | BaAl₂Si₂O₈ | 735.2 | 1.0971 |
| 3.2 | SrAl₂Si₂O₈ | 700.7 | 42 | BaAl₂Si₂O₈ | 735.2 | 1.0492 |
| 3.3 | Na₂Mg₅Si₁₂O₃₀ | 1275.03 | 49 | K₂Mg₅Si₁₂O₃₀ | 1280.62 | 1.0044 |
| 3.4 | RbZr₂P₃O₁₂ | 1583.72 | −10 | CsZr₂P₃O₁₂ | 1591.90 | 1.0052 |
| 3.5a | KZr₂P₃O₁₂ | 1576.45 | −9 | RbZr₂P₃O₁₂ | 1583.72 | 1.0046 |
| 3.5b | | | | CsZr₂P₃O₁₂ | 1591.90 | 1.0098 |
| 3.6a | LiZr₂P₃O₁₂ | 1526.05 | 15 | NaZr₂P₃O₁₂ | 1527.88 | 1.0012 |
| 3.6b | | | | KZr₂P₃O₁₂ | 1576.45 | 1.0330 |
| 3.6c | | | | RbZr₂P₃O₁₂ | 1583.72 | 1.0378 |
| 3.6d | | | | CsZr₂P₃O₁₂ | 1591.90 | 1.0432 |
| 3.7a | NaZr₂P₃O₁₂ | 1527.88 | 46 | KZr₂P₃O₁₂ | 1576.45 | 1.0318 |
| 3.7b | | | | RbZr₂P₃O₁₂ | 1583.72 | 1.0365 |
| 3.7c | | | | CsZr₂P₃O₁₂ | 1591.90 | 1.0419 |
| 3.8 | KTi₂P₃O₁₂ | 1396.71 | 26 | RbTi₂P₃O₁₂ | 1402.20 | 1.0039 |
| 3.9a | NaTi₂P₃O₁₂ | 1360.36 | 47 | KTi₂P₃O₁₂ | 1396.71 | 1.0267 |
| 3.9b | | | | RbTi₂P₃O₁₂ | 1402.20 | 1.0308 |
| 3.10a | CaZr₄P₆O₂₄ | 1516.06 | 15 | SrZr₄P₆O₂₄ | 1530.85 | 1.0098 |
| 3.10b | | | | BaZr₄P₆O₂₄ | 1552.97 | 1.0243 |
| 3.11 | SrZr₄P₆O₂₄ | 1530.85 | 29 | BaZr₄P₆O₂₄ | 1552.97 | 1.0144 |
| 3.12a | CaTi₄P₆O₂₄ | 1331.26 | 63 | SrTi₄P₆O₂₄ | 1343.57 | 1.0092 |
| 3.12b | | | | BaTi₄P₆O₂₄ | 1389.37 | 1.0437 |
| 3.13a | Li_{0.5}Mg₂Al_{4.5}Si_{4.5}O₁₈ | 777.90 | 24 | Na_{0.5}Mg₂Al_{4.5}Si_{4.5}O₁₈ | 780.59 | 1.0035 |
| 3.13b | | | | K_{0.5}Mg₂Al_{4.5}Si_{4.5}O₁₈ | 780.68 | 1.0036 |
| 3.13c | | | | Cs_{0.5}Mg₂Al_{4.5}Si_{4.5}O₁₈ | 781.20 | 1.0042 |

### Examples Based Upon a Wear-Resistant Layer Having a High Hardness

In some embodiments, the main body 312, 412, 612 of the ferrule 310, 410, 610 may be provided with a coating (e.g., layer 326, 426, 626) having a high intrinsic hardness. Such coatings include, but are not limited to, ceramics and cermets based upon silicon carbide, silicon nitride, and the carbides, nitrides, and borides of certain transition metals such as titanium, zirconium, hafnium, tantalum, and tungsten, and of other metals such as aluminum and boron. It is preferred that the wear-resistant coating also exhibit high fracture toughness.

The construction and arrangements of the connectors and ferrules, as shown in the various exemplary embodiments, are illustrative only. For example, any of the above embodiments provided in the present disclosure may be used with multi-fiber ferrules (see, e.g., ferrule 710 as shown in FIG. 7 with structures 224, 228 of FIG. 2; see also structures 326, 328, 424, 426, 428, 526, 624, 626 of FIGS. 3-6, which may be used with a multi-fiber ferrule 710 as shown in FIG. 7), such as those with a plurality of bores 714 to receive more than one optical waveguide (e.g., for MTP connectors), and/or may be used with multi-core optical fibers. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. For example, the term “include,” and its variations, such as “including,” as used herein, in the alternative, means “comprising,” “primarily consisting of,” “consisting essentially of,” and/or “consisting of,” where possible in the particular usage herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present innovative and inventive technology.

What is claimed is:

1. A ferrule for receiving an optical waveguide, wherein the ferrule has an exterior and a bore defined by an interior surface of the ferrule, the ferrule comprising:
a main body formed from a first material comprising at least one of a glass, a glass-ceramic, a ceramic, and a cermet having a mean coefficient of thermal expansion of 60×10⁻⁷° C.⁻¹ or less at temperatures between room temperature of 25° C. and at least 800° C.; and
wherein the interior surface of the ferrule defining the bore comprises a silica or silica-rich material provided either by the body of the ferrule or by a layer of a second material.

2. The ferrule of claim 1, wherein the first material has a coefficient of thermal expansion of less than 35×10⁻⁷° C.⁻¹.

3. The ferrule of claim 2, wherein the first material has a Vickers hardness of at least 10 GPa and a fracture toughness of at least 5 MPa m^{1/2}.

4. The ferrule of claim 3, wherein thermal conductivity of the first material is at least 5 W/(m·K).

5. The ferrule of claim 4, wherein the silica or silica-rich surface of the interior of the ferrule is provided as a layer of a second material having a thickness of less than 50 micrometers.

6. A ferrule for receiving an optical waveguide, wherein the ferrule has an exterior and a bore defined by an interior surface of the ferrule, the ferrule comprising:
a main body formed from a first material comprising at least one of a glass, a glass-ceramic, a ceramic, and a cermet; and
a thin layer of at least one of a glass, glass-ceramic, ceramic, and cermet on the exterior of the ferrule; and
wherein the interior surface of the ferrule defining the bore comprises a silica or silica-rich material provided either by the body of the ferrule or by a layer of a second material.

7. The ferrule of claim 6, wherein the thin layer on the exterior of the ferrule additionally extends through the bore.

8. The ferrule of claim 7, wherein the layer of the second material provides the silica or silica-rich material of the interior surface of the ferrule defining the bore, and wherein the thin layer on the exterior of the ferrule is formed from the second material and is integrally connected to the layer of the second material on the interior surface.

9. The ferrule of claim 7, wherein the layer of the second material provides the silica or silica-rich material of the interior surface of the ferrule defining the bore, and wherein the thin layer on the exterior of the ferrule extends through the bore beneath the layer of the second material on the interior surface of the ferrule.

10. The ferrule of claim 6, wherein the thin layer on the exterior of the ferrule is of a third material.

11. The ferrule of claim 6, wherein the exterior surface of the ferrule has a Vickers hardness of at least 10 GPa and a fracture toughness of at least 5 MPa m^{1/2} provided by the thin layer on the exterior of the ferrule.

12. A ferrule for receiving an optical waveguide, wherein the ferrule has an exterior and a bore defined by an interior surface of the ferrule, the ferrule comprising:
a main body formed from a first material comprising at least one of a glass, a glass-ceramic, a ceramic, and a cermet; and
a thin layer of at least one of a glass, glass-ceramic, ceramic, and cermet on the exterior of the ferrule, wherein the thin layer on the exterior of the ferrule is in a state of compression under ambient-use conditions including sea-level atmospheric pressure, 25° C. room temperature, and zero humidity.

13. The ferrule of claim 12, wherein the thin layer on the exterior of the ferrule is integrally formed with the main body of the ferrule but chemically modified from the first material via replacement of one or more cations or anions in the first material.

14. The ferrule of claim 12, wherein the first material has a mean coefficient of thermal expansion of 60×10⁻⁷° C.⁻¹ or less at temperatures between room temperature of 25° C. and at least 800° C. and the thin layer on the exterior of the ferrule has a coefficient of thermal expansion that is at least 10×10⁻⁷° C.⁻¹ less than that of the first material.

15. The ferrule of claim 14, wherein the thin layer on the exterior of the ferrule is characterized by a calculated compressive stress σ=E(ΔCTE)(ΔT)/(1−ν) of at least 200 MPa, wherein E is the Young's elastic modulus of the thin layer on the exterior of the ferrule, ΔCTE is equal to the CTE of the first material minus the CTE of the thin layer on the exterior of the ferrule, ΔT is the difference in temperature between the temperature at which the thin layer on the exterior of the ferrule was annealed and room temperature in Celsius or Kelvin, and ν is the Poisson's ratio of the thin layer on the exterior of the ferrule.

16. The ferrule of claim 12, wherein the thin layer on the exterior of the ferrule comprises an amorphous or glassy silica or silica-rich phase.

17. The ferrule of claim 12, wherein the interior surface of the ferrule defining the bore comprises a silica or silica-rich material provided either by the body of the ferrule or by a layer of a second material.

18. The ferrule of claim 12, wherein the interior surface of the ferrule defining the bore comprises a silica or silica-rich material provided either by the body of the ferrule or by a layer of a second material, and wherein the thin layer on the exterior of the ferrule is of a third material.

19. The ferrule of claim 12, wherein the thin layer on the exterior of the ferrule is integrally formed with the main body of the ferrule but chemically modified from the first material via replacement of one or more cations or anions in the first material whereby the thin layer on the exterior of the ferrule material has a molar volume that is greater than that of the first material.

20. The ferrule of claim 19, wherein the molar volume of the thin layer on the exterior of the ferrule is at least 1.0% greater than the molar volume of the material of the main body of the ferrule.
